(19) United States
(12) Patent Application Publication
(10) Pub. No.: US 2015/0339606 A1
(43) Pub. Date: Nov. 26, 2015

(54) DYNAMIC METHODS SYSTEMS AND DEVICES FOR ASSESSING RISK IN ENERGY-RELATED ASSETS

(71) Applicants: David Arfin, Palo Alto, CA (US); Nalin Kulatilaka, Brookline, MA (US)

(72) Inventors: David Arfin, Palo Alto, CA (US); Nalin Kulatilaka, Brookline, MA (US)

(21) Appl. No.: 14/719,136

(22) Filed: May 21, 2015

Related U.S. Application Data
(60) Provisional application No. 62/001,058, filed on May 21, 2014.

(51) Int. Cl. G06Q 10/06; G06Q 50/06

(52) U.S. Cl. CPC G06Q 10/0635; G06Q 50/06

(57) ABSTRACT

Devices, systems, and methods for assessing risk or value in energy-related assets are disclosed. In one aspect a dynamic computerized method for calculating a likelihood that an end-user will fulfill obligations on an asset associated with energy-related equipment is disclosed. In another aspect a dynamic computerized method for calculating a likelihood that an end-user will renew the energy-related asset or enter into a new agreement for a new energy-related asset at the end of the term of the energy-related asset is disclosed.

### CROSS-REFERENCES TO RELATED APPLICATIONS

This application claims the benefit and priority of U.S. Provisional Application No. 62/001,058, entitled “DYNAMIC METHODS SYSTEMS AND DEVICES FOR ASSESSING RISK IN ENERGY-RELATED ASSETS”, filed on May 21, 2014, the full disclosure of the above referenced application is incorporated herein by reference.

### FIELD OF THE INVENTION

This invention relates generally to methods, systems, and devices for assessing risk or value in energy-related assets.

### DESCRIPTION OF THE RELATED ART

Energy generating or energy efficiency equipment can provide substantial utility savings as well as environmental benefits. Often though, purchasing this equipment may be prohibitively expensive and it might take a long time to recoup the initial investment through savings derived from the system. Assets such as equipment loans, equipment leases, and power purchase agreements have been created in order to reduce or remove upfront cost allowing a much larger user base.

In order for investors, developers, lenders, or installers to gauge the risk involved in these assets, factors such as credit rating of the user, utility rates, etc. are often examined before creating the asset or installing equipment. Assets such as these may have long terms and thus risk factors could change significantly during the life of the asset. These static determinations of risk therefore poorly represent risk after creation of the asset and adoption of equipment.

It would be desirable to provide alternative and improved methods, systems, and devices for assessing risk in energy-related assets. At least some of these objectives will be met by the invention described herein below.

### SUMMARY OF THE INVENTION

In one aspect, the present application discloses methods, systems, and devices for assessing risk or value in energy-related assets. In one embodiment a dynamic computerized method for assessing risk in energy-related assets associated with energy-related equipment comprises obtaining a previously calculated score reflecting a likelihood that an end-user will fulfill obligations on the energy-related asset. The method further comprises receiving by a processor, energy-related data associated with the asset, and recalculating by the processor, the score reflecting the likelihood that the end-user will fulfill obligations on the energy-related asset based on the received data. The data is received after adoption of the equipment by the end-user and comprises data representing additional factors not used in calculating the previously calculated score or data representing changes to factors used in calculating the previously calculated score.

In another embodiment a dynamic computerized method for assessing value in energy-related assets associated with energy-related equipment comprises obtaining a previously calculated score reflecting a likelihood that an end-user will renew the energy-related asset or enter into a new agreement for a new energy-related asset at the end of a term of the energy-related asset. The method further comprises receiving by a processor, energy-related data associated with the asset, and recalculating by the processor, the score reflecting the likelihood that an end-user will renew the energy-related asset or enter into a new agreement for a new energy-related asset at the end of a term of the energy-related asset based on the received data. The data is received after adoption of the equipment by the end-user and comprises data representing additional factors not used in calculating the previously calculated score or data representing changes to factors used in calculating the previously calculated score. The obtaining, receiving, and recalculating steps are performed during the term of the energy-related asset.

In one aspect, the energy-related asset is an equipment lease, an equipment loan, a power purchase agreement, or an energy service agreement. In various embodiments, the equipment comprises photovoltaic, solar thermal, wind energy, heating, cooling, HVAC, insulation, water processing, or water purifying equipment. The received data may comprise data relating to changes to regulations, taxes, government incentives, utility incentives, manufacturer incentives, end-user credit data, end-user financial data, usage data, equipment performance data, utility pricing, macroeconomic data, weather, equipment servicing data, technology data, or asset payments.

The methods may additionally comprise calculating by the processor, a monetary value of the energy-related asset based on the recalculated score, selling the energy-related asset, or bundling multiple energy-related assets.

This, and further aspects of the present embodiments are set forth herein.

### BRIEF DESCRIPTION OF THE DRAWINGS

Present embodiments have other advantages and features which will be more readily apparent from the following detailed description and the appended claims, when taken in conjunction with the accompanying drawings, in which:

FIG. 1 shows one embodiment of a dynamic method of assessing risk that an end-user will fulfill obligations on an energy-related asset.

FIG. 2 shows one embodiment of a dynamic method for assessing value in energy-related assets by determining a likelihood a that an end-user will renew the energy-related asset or enter into a new agreement for a new energy-related asset at the end of a term of the energy-related asset.

FIG. 3 shows one embodiment of a dynamic method of recalculating a risk or value score for an energy-related asset.

FIG. 4 shows one embodiment of an exemplary system architecture according to one embodiment.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The word “exemplary” is used herein to mean “serving as an example, instance, or illustration.” Any implementation described herein as “exemplary” is not necessarily to be construed as advantageous over other implementations.

The present disclosure describes methods, systems, and devices for dynamically assessing risk or value in energy-related assets associated with energy-related equipment after adoption of the asset by an end-user. The term “energy-related equipment” as referred to herein is defined to include energy generating systems (photovoltaic, solar hot water, solar thermal, wind energy, geothermal energy, hydroelectric), distributed energy equipment, energy or water efficient equipment (appliances, lighting, HVAC, insulation, smart devices, sensors), heating/cooling systems (heating oil, gas, geothermal heat pumps), energy storage systems (battery storage and fuel cell systems), systems for cleaning, processing, storing, or purifying water, energy efficient vehicles (electric, hybrid, fuel cell, etc.), and/or software that allocates/optimizes generation or usage of the above systems.

Energy-related equipment may provide substantial energy or utility savings to residential, commercial, industrial, agricultural, governmental, educational, nonprofit, or any other user of energy or water. Often though, the initial investment to adopt such equipment can be quite large. Energy-related assets such as equipment leases, equipment loan, power purchase agreements, energy service agreements, or the like, allow adoption of such equipment with reduced upfront cost to end-users of the energy-related equipment. Assets may have terms of any length with one or more options to renew. Energy-related assets may have cash flows of various durations that are borrowed against and/or sold into securitization markets. Assets may be packaged or bundled with similar assets. They may, in turn, be repackaged, re-priced and resold.

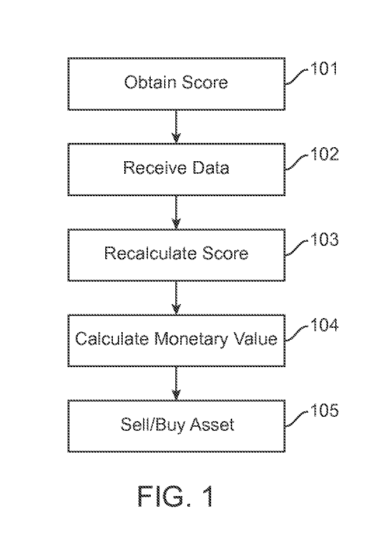

FIG. 1 shows one embodiment of a dynamic method of assessing risk that an end-user will fulfill obligations on an energy-related asset. At step 101, in some aspects, a previously calculated score reflecting a likelihood that an end-user will fulfill obligations on the energy-related asset is obtained. The obtained score may be a score calculated before or after adoption of the energy-related equipment by the end-user. Additionally or alternatively, data used in calculating the previously calculated score may be obtained.

At step 102, in some aspects, energy-related data associated with the asset is received. Received data may be any data relevant to whether the end-user will fulfill obligations on the energy-related asset such as data relating to regulations, taxes, government incentives, utility incentives, manufacturer incentives, end-user credit, equipment usage, equipment performance, utility pricing, weather, end-user financial data, macroeconomic data, equipment servicing data, technology data, and/or asset payments. In one embodiment, the data is received after creation of the asset and adoption of equipment associated with the asset by the end-user. The received data may comprise data representing additional factors not used in calculating the previously calculated score. The received data may also comprise data representing changes to factors used in calculating the previously calculated score.

At step 103, in some aspects, the score reflecting the likelihood that the end-user will fulfill obligations on the energy-related asset is recalculated based on the received data. The recalculation may further be based on the score or data obtained in step 101.

At step 104, in some aspects, a monetary value of the energy-related asset is calculated based on the recalculated score. The energy-related asset may then be sold or purchased at step 105.

One or more energy-related assets may be bundled. A monetary value of the bundled assets may then be calculated and the bundled assets may be sold or purchased. Bundling may occur before or after the calculation at step 103, the calculation of a monetary value at step 104, or the purchase or sale at step 105.

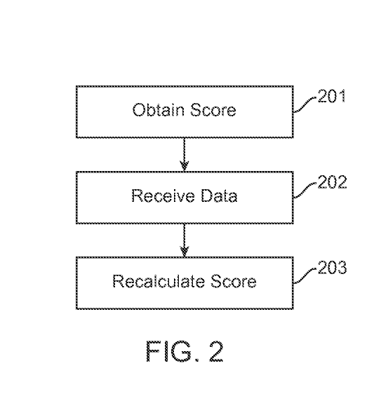

Energy-related assets may have terms of any length with one or more options to renew. FIG. 2 shows one embodiment of a dynamic method for assessing value in energy-related assets by determining a likelihood that an end-user will renew the energy-related asset or enter into a new agreement for a new energy-related asset at the end of a term of the energy-related asset. For example, a solar equipment lease may have a twenty year term with an option to renew.

At step 201, in some aspects, a previously calculated score reflecting a likelihood that an end-user will renew the energy-related asset or enter into a new agreement for a new energy-related asset at the end of the term of the energy-related asset is obtained. The obtained score may be a score calculated before or after adoption of the energy-related equipment by the end-user. Additionally or alternatively, data used in calculating the previously calculated score may be obtained.

At step 202, energy-related data associated with the asset is received. Received data may be any data relevant to whether the end-user will renew the energy-related asset or enter into a new agreement for a new energy-related asset at the end of the term of the energy-related asset such as data relating to regulations, taxes, government incentives, utility incentives, manufacturer incentives, end-user credit, equipment usage, equipment performance, utility pricing, weather, end-user financial data, macroeconomic data, equipment servicing data, technology data, and/or asset payments. In an embodiment, the data is received after creation of the asset and adoption of equipment associated with the asset by the end-user. The received data may comprise data representing additional factors not used in calculating the previously calculated score. The received data may also comprise data representing changes to factors used in calculating the previously calculated score.

At step 203, in some aspects, the score reflecting the likelihood that the end-user will renew the energy-related asset or enter into a new agreement for a new energy-related asset at the end of the term of the energy-related asset is recalculated based on the received data. The recalculation may further be based on the score or data obtained in step 201.

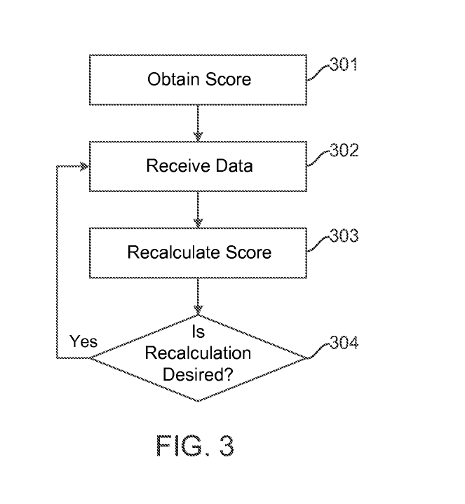

In some aspects, the processes in FIG. 1 or 2 may be repeated multiple times continuously or periodically in order to dynamically adjust the risk, value, or price over time due to changes in relevant factors. FIG. 3 shows one embodiment of a dynamic method of recalculating a risk or value score for an energy-related asset. At step 301, in some aspects, a previously calculated score reflecting risk or value for a new energy-related asset is obtained. The obtained score may be a score calculated before or after adoption of the energy-related equipment by the end-user. Additionally or alternatively, data used in calculating the previously calculated score may be obtained.

At step 302, in some aspects, energy-related data associated with the asset is received. Received data may be any data relevant to the energy-related asset such as data relating to regulations, taxes, government incentives, utility incentives, manufacturer incentives, end-user credit, equipment usage, equipment performance, utility pricing, weather, end-user financial data, macroeconomic data, equipment servicing data, technology data, and/or asset payments. In an embodiment, the data is received after creation of the asset and adoption of equipment associated with the asset by the end-user. The received data may comprise data representing additional factors not used in calculating the previously calculated score. The received data may also comprise data representing changes to factors used in calculating the previously calculated score.

At step 303, in some aspects, the score reflecting risk or value is recalculated based on the received data. The recalculation may further be based on the score or data obtained in step 301.

At step 304, the system determines if recalculation is desired. In one embodiment, determining if recalculation is desired comprises determining if additional data is available. In another embodiment, determining if recalculation is desired comprises determining how much time has passed since the previous calculation. If it is determined that recalculation is desired, then step 302 is repeated. The process of receiving data 302, recalculating the score 303, and determining if recalculation is desired 304 may be repeated multiple times continuously or periodically in order to dynamically adjust the risk, value, or price over time due to changes in relevant factors.

Any of the steps, operations, or processes described herein may be performed or implemented with one or more hardware or software modules, alone or in combination with other devices. In one embodiment, a software module is implemented with a computer program product comprising a computer-readable medium. The computer-readable medium contains a computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in a computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

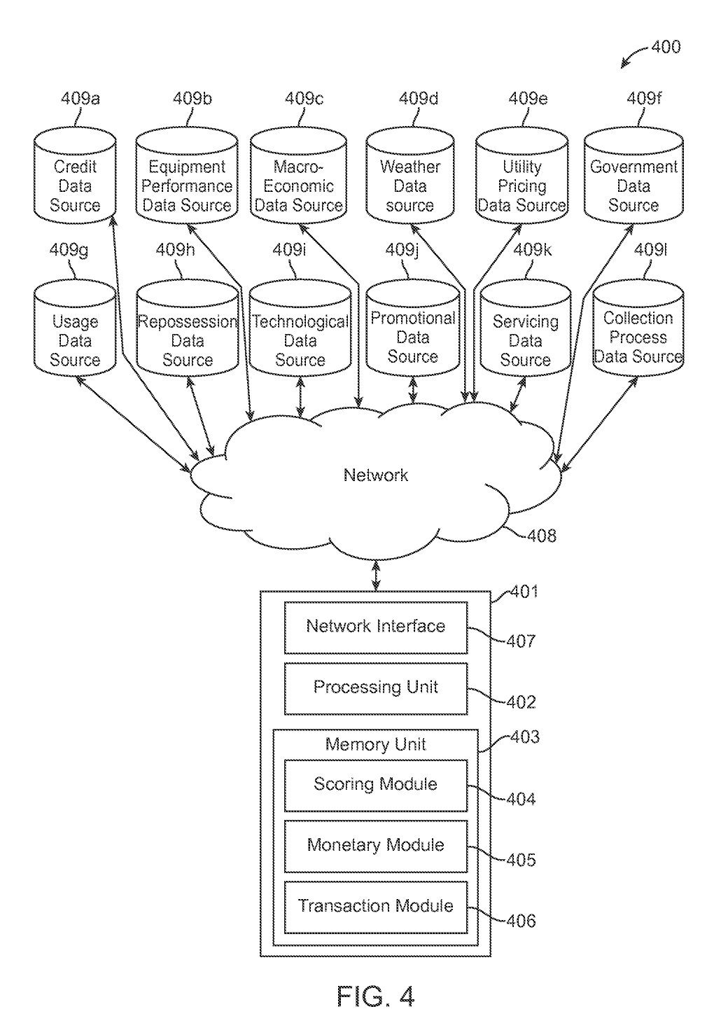

FIG. 4 illustrates an exemplary system architecture according to one embodiment. The system 400 may comprise one or more computing devices 401, one or more data sources 409a-l, and one or more networks 408. The computing device 401 is configured to communicate with data sources 409a-l over the network 408. Computing device 401 may comprise various components including but not limited to one or more processing units 402, memory units 403, video or display interfaces, network interfaces 407, input/output interfaces and buses that connect the various units and interfaces. The network interface 407 enables the computing device 401 to connect to the network 408. The memory unit 403 may comprise random access memory (RAM), read only memory (ROM), electronic erasable programmable read-only memory (EEPROM), and basic input/output system (BIOS). The memory unit 403 may further comprise other storage units such as non-volatile storage including magnetic disk drives, optical drives, flash memory and the like. In one embodiment the memory may comprise a scoring module 404 configured to calculate a risk or value score, a monetary module 405 configured to calculate a monetary value for assets or bundles of assets, and a transaction module 406 configured to sell or buy assets or bundles of assets. The modules 404, 405, 406 may be implemented as software code to be executed by the processing unit 402 using any suitable computer language. The software code may be stored as a series of instructions or commands in the memory unit 403.

While FIG. 4 depicts one computing device 401, one network 406, and twelve data sources 409a-l, this is meant as merely exemplary. Alternatively, any number of computing devices 401, networks 406, or data sources 409a-l may be present. Some or all of the components of the computing device 401 and/or the data sources 409a-l may be combined into a single component. Likewise, some or all of the components of the computing device 401 and/or the data sources 409a-l may be separated into separate components.

Data sources 409a-l provide data feeds that inform on events or factors related to the adopted equipment. This data may then be used to dynamically adjust scoring and pricing accordingly. Data sources 409a-l may contain current data, historic data, and/or projected data.

Credit data source 409a provides updated or additional data relating to the credit or finances of the end-user. Over the term of an asset, the end-user credit may change significantly due to late payments, additional debt, bankruptcy, disability, changes in income, death, divorce, changes in home value or equity, etc. Additionally, the end-user may change over the term of an asset. For example, a home having solar equipment installed may be sold to a new end-user.

Equipment performance data source 409b provides data relating to the performance of the adopted equipment. Equipment performance may change over time due to many factors such as weather, quality, maintenance, or usage patterns. Adopted equipment may be monitored and performance can be rated based on actual performance. In one embodiment the equipment performance data source 409b comprises sensors or other equipment adopted by the end-user.

Macroeconomic data source 409c provides macroeconomic data at world, national, state, or local levels such as inflation/deflation data, CPI rates, employment data, commodity price data, home price data, recession/depression data, etc. which can be used to determine the likelihood of an end-user fulfilling obligations on the asset. For example, during a recession default on obligations may be more likely. Additionally, after high inflation, locked in energy rates may be appealing, therefore the user will be more likely to fulfill obligations.

Weather data source 409d may provide data relating to changes to average temperatures, precipitation, sunlight, wind, or other weather over time, hot or cold spikes in temperature, drought, flooding, earthquakes, natural disasters, or seasonal variation weather.

Utility pricing data source 409e provides data relating to changes to the price of energy or water. Increases in utility rates may incent users to fulfill the obligations of the asset while decreases or slower than expected increases in utility rates may incent users to default on obligations. Data may include changes in tariff structures (net metering, tiering of rates, demand changes, time-of-use pricing, fixed rates, variable rates, etc.), energy or water rationing, regulation or deregulation, carbon taxes or credits, per unit rates, transmission fees, distribution policies, fuel mix, fuel prices, or events such as an oil embargo, refinery fires, closing or opening of utility plants.

Government data source 409f may provide government related data at the federal, state, or local level relevant to the asset. Data may include information relating to tax rate changes, new forms of taxes, tax treatment changes, changes to statutes or regulations, legal or administrative rulings, government incentives, changes to policies, or political forces.

Usage data source 409g may provide usage statistics for the energy-related equipment or utilities. In an embodiment, usage data source 409g comprises sensors, appliances, smart devices, meters, or other energy-related equipment adopted by the end-user. In another embodiment usage data is collected from a utility. Usage data may include data relating to past, current, or projected future usage. Usage data may also include energy consumption or production data, equipment use data, time of use data, duration of use data, or end-user behavioral data. Changes to expected usage may also be determined based on various factors such as addition or subtraction of appliances or vehicles, addition or subtraction of energy generating equipment or distributed energy equipment, addition or subtraction of energy/water storage capabilities, changes to heating/cooling equipment, new or updated efficiency equipment or software, changes to equipment for cleaning, processing, storing, or purifying water, changes in time of use, changes in usage of the premises such as usage of the home as an office, etc., change in the number of occupants and intensity of usage, modifications to the property such as expansion or contraction, transfer of ownership, or change in occupants.

Repossession data source 409h provides data on the repossession characteristics of the adopted equipment. The cost/benefit of repossession depends on the equipment. Data is provided on the ease of removal, market for used equipment, value of used equipment, location, transaction costs, legal costs, repossession laws, removal costs, or cost to place equipment elsewhere. These factors could change over time and the equipment could depreciate or appreciate. As an example, equipment such as an electric vehicle can easily be repossessed and resold. Removal costs for used insulation on the other hand may be more than the retained value.

Technological data source 409i provides data relating to technological changes which may make the adopted equipment obsolete or less desirable. For example, improved versions of the equipment or new types of equipment that are more efficient or have additional features may emerge during the lifetime of the asset that incent the user to switch. Additionally, technological data source 409i may provide cosmetic obsolescence information. For example, photovoltaic panels may fade or be considered unattractive over time.

Promotional data source 409j may provide promotional data from public or private sources such as manufacturers, utilities, installers, sellers, or government that accelerate adoption. For example, a new rebate, credit, and/or incentive may exist to replace existing with new equipment. Existing incentives may also be removed over time. There may also be negative promotions such as assessments, penalties, use fees, connection charges, new taxes, etc.

Servicing data source 409k may provide information on maintenance of equipment, warranties, guarantees, or changes to whether an installer, manufacturer, or servicer is operating in the relevant territory. Data may also include changes to the credit or finances of installers, manufactures, or servicers.

Collection process data source 409l provides data relating to how are payments made and how payments change over time. In an embodiment, interest rates or payments may vary over time. Data may include information on the payment method such as through the Automated Clearing House (ACH) or other electronic payment, check, money order, credit or debit card, wire transfer, etc. Payments may be made through tax assessments such as Property Assessed Clean Energy (PACE) or Mello-Roos property tax assessments or through the sale of bonds. Data may include whether payment is automatic or a bill is sent. Additionally, information may be provided on whether there are intermediaries or guarantors involved. Data may include whether an owner or tenant of the property makes the payments.

The various components depicted in FIG. 4 may comprise computing devices or reside on computing devices such as servers, desktop computers, laptop computers, tablet computers, personal digital assistants (PDA), smartphones, mobile phones, smart devices, appliances, sensors, or the like. Computing devices may comprise processors, memories, network interfaces, peripheral interfaces, and the like. Some or all of the components may comprise or reside on separate computing devices. Some or all of the components depicted may comprise or reside on the same computing device.

The various components as depicted in FIG. 4 may be configured to communicate directly or indirectly with a wireless network such as through a base station, a router, switch, or other computing devices. In an embodiment, the components may be configured to utilize various communication protocols such as Global System for Mobile Communications (GSM), General Packet Radio Services (GPRS), Enhanced Data GSM Environment (EDGE), Code Division Multiple Access (CDMA), Wideband Code Division Multiple Access (WCDMA), Bluetooth, High Speed Packet Access (HSPA), Long Term Evolution (LTE), and Worldwide Interoperability for Microwave Access (WiMAX).

The components may be further configured to utilize user datagram protocol (UDP), transport control protocol (TCP), Wi-Fi, satellite links and various other communication protocols, technologies, or methods. Additionally, the components may be configured to connect to an electronic network without communicating through a wireless network. The components may be configured to utilize analog telephone lines (dial-up connection), digital lines (T1, T2, T3, T4, or the like), Digital Subscriber lines (DSL), Ethernet, or the like. It is further contemplated that the components may be connected directly to a computing device through a USB port, Bluetooth, infrared (IR), Firewire port, thunderbolt port, ad-hoc wireless connection, or the like. Components may be configured to send, receive, and/or manage messages such as email, short message service (SMS), instant message (IM), multimedia message services (MMS), or the like.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A dynamic computerized method for assessing risk in energy-related assets comprising:
obtaining a previously calculated score reflecting a likelihood that an end-user will fulfill obligations on an energy-related asset;
receiving by a processor, energy-related data associated with the asset, wherein the data is received after adoption of an equipment associated with the asset by the end-user, and the received data comprises data representing additional factors not used in calculating the previously calculated score or data representing changes to factors used in calculating the previously calculated score; and
recalculating by the processor, the score reflecting the likelihood that the end-user will fulfill obligations on the energy-related asset, wherein the recalculated score is recalculated based on the received data.

2. The method of claim 1, wherein the energy-related asset is an equipment lease, an equipment loan, a power purchase agreement, or an energy service agreement.

3. The method of claim 1, further comprising calculating by the processor a monetary value of the energy-related asset based on the recalculated score.

4. The method of claim 1, further comprising selling the energy-related asset.

5. The method of claim 1, further comprising bundling multiple energy-related assets and selling the bundle of energy-related assets.

6. The method of claim 1, wherein the end-user has changed since the previous score was calculated and the received data comprises data relating to the new end-user.

7. The method of claim 1, wherein the received data comprises data relating to changes to regulations, taxes, government incentives, utility incentives, or manufacturer incentives.

8. The method of claim 1, wherein the received data comprises changes to end-user credit data, end-user financial data, usage data, warranty data, guarantee data, or equipment performance data.

9. The method of claim 1, wherein the received data comprises data relating to utility pricing changes.

10. The method of claim 1, wherein the received data comprises data relating to changes to macroeconomic, weather, equipment servicing, or technology data.

11. The method of claim 1, wherein the received data comprises data relating to how asset payments are made by the end-user, how asset payments change over time, or repossession characteristics of the equipment.

12. The method of claim 1, wherein the equipment comprises photovoltaic, solar thermal, energy storage, or wind energy equipment.

13. The method of claim 1, wherein the equipment comprises heating, cooling, HVAC, lighting, or insulation equipment.

14. The method of claim 1, wherein the equipment comprises water cleaning, processing, or purifying equipment.

15. A dynamic computerized method for assessing value in energy-related assets comprising:
obtaining a previously calculated score reflecting a likelihood that an end-user will renew an energy-related asset or enter into a new agreement for a new energy-related asset at the end of a term of the energy-related asset;
receiving by a processor, energy-related data associated with the asset, wherein the data is received after adoption of an equipment associated with the asset by the end-user, and the received data comprises data representing additional factors not used in calculating the previously calculated score or data representing changes to factors used in calculating the previously calculated score; and
recalculating by the processor, the score reflecting the likelihood that an end-user will renew the energy-related asset or enter into a new agreement for a new energy-related asset at the end of a term of the energy-related asset, wherein the recalculated score is recalculated based on the received data;
wherein the obtaining, receiving, and recalculating steps are performed during the term of the energy-related asset.

16. The method of claim 15, wherein the energy-related asset is an equipment lease, an equipment loan, a power purchase agreement, or an energy service agreement.

17. The method of claim 15, wherein the equipment comprises photovoltaic, solar thermal, wind energy, energy storage, heating, cooling, HVAC, insulation, lighting, water processing, or water purifying equipment.

18. The method of claim 15, wherein the received data comprises data relating to changes to regulations, taxes, government incentives, utility incentives, manufacturer incentives, utility pricing, or asset payments.

19. The method of claim 15, wherein the received data comprises changes to end-user credit data, end-user financial data, usage data, warranty data, guarantee data, or equipment performance data.

20. The method of claim 15, wherein the received data comprises data relating to changes to macroeconomic, weather, equipment servicing, or technology data.
